(19) United States
(12) Patent Application Publication
(10) Pub. No.: US 2023/0000262 A1
(43) Pub. Date: Jan. 5, 2023

(54) AIR BAG SELF-CHECKING SYSTEM AND METHOD

(71) Applicant: SHENZHEN ONETHIRD SLEEP TECHNOLOGY CO., LTD, Shenzhen (CN)

(72) Inventors: Chengjun SUN, Shenzhen (CN); Zhong LIU, Shenzhen (CN); Kuntao LU, Shenzhen (CN); Yong LE, Shenzhen (CN)

(21) Appl. No.: 17/636,384

(22) PCT Filed: Mar. 23, 2020
(86) PCT No.: PCT/CN2020/080704

§ 371 Date: Mar. 4, 2022

(51) Int. Cl. A47C 27/08; A47C 31/00

(52) U.S. Cl. CPC A47C 27/083; A47C 31/00

(57) ABSTRACT

A self-checking system for an air bag includes a client, a detection module, an air bag control unit and an air bag device. The air bag control unit is connected with the air bag device; the air bag device includes an air bag and an air path; and the detection module is configured for detecting the air bag device and the air bag control unit according to preset steps.

### CROSS-REFERENCE TO RELATED APPLICATIONS

The present application is a continuation of International Application No. PCT/CN2020/080704, with an international filing date of Mar. 23, 2020, the entire content of which is incorporated herein by reference.

### TECHNICAL FIELD

The present disclosure relates to the technical field of intelligent beds, specifically to a self-checking system and method for an air bag.

### BACKGROUND

Sleep is a very important part of life, and a body pressure during sleep is closely related to the sleep health. At present, people attach great importance to the sleep quality, so the requirements for sleep carrier mattresses are getting higher and higher. At present, some mattresses on the market can achieve real-time adjustment of body pressures for different groups of people in various sleeping positions, thereby improving the sleep quality. The adjustment of the body pressure can be achieved by an air bag mattress. The air bag mattress can be inflated and deflated by an air bag to adjust the hardness of the mattress, so as to adjust the body pressure during the sleep. Key components of an intelligent air bag adjustment mattress include an air bag, an air valve, an air pump, an air pressure sensor, and other elements, and the life of each element is related to the normal operation of the entire system. After a period of time of use, each element may have some failures. How to prevent and clear away these failures is a common problem in the current intelligent adjustment mattress.

For the existing intelligent adjustment mattresses on the market, after users find that a product is not working properly, sometimes they cannot determine the source of the problem, and sometimes system failures even cause certain dangers. For example, when the air bag in the air bag adjustment mattress is always inflated, the air bag will explode, or the air pump or the air valve will work all the time, and the temperature will rise, which causes a certain safety hazard. Once the system does not work properly, in the existing solution, it is found that the mattress cannot work, or is in an abnormal working state (the air bag adjustment is not in place), and maintenance personnel is notified for on-site repair, or the product is returned. The main reason for these problems is that it is impossible to quickly locate the fault of the adjustment air bag and the air bag cannot achieve self-repair at the same time. These problems need to be solved urgently.

### SUMMARY

In order to solve the above problems, the present disclosure provides a self-checking system for an air bag, which can quickly and effectively find the fault of a mattress system with an air bag adjustment device, can achieve self-repair and adjustment, facilitates subsequent after-sales maintenance services, and avoids potential hazard of explosion of an air bag.

An embodiment of the present disclosure provides a self-checking system for an air bag, including a client, a detection module, an air bag control unit and an air bag device. The air bag control unit is connected with the air bag device; the air bag device includes an air bag and an air path; and the detection module is used for detecting the air bag device and the air bag control unit according to set steps.

Further, the client is a user control platform; the client communicates with the air bag control unit in a wired or wireless manner and is used for transmitting a detection instruction and displaying a detection result and related parameters.

Further, the self-checking system for the air bag further includes a correction module used for receiving the detection result transmitted by the detection module, analyzing the result, and correcting the parameters of the self-checking system for the air bag.

Preferably, the corrected parameters include at least one of an inflating and deflating order of the air bag, inflating and deflating time of the air bag, whether the air bag is inflated and deflated, and a detected value of an air pressure sensor.

Preferably, the air bag control unit includes an air pressure sensor, an air pump, an air valve, a communication unit, and a main control unit; the air pressure sensor is connected with the air bag device and is used for detecting an air pressure of the air bag; the air pump is a power unit for inflating or deflating the air bag; the air valve is opened and closed to achieve gating of the air bag and cooperates with the air pump to achieve inflation and deflation of the air bag; the main control unit is used for controlling the air pump and the air valve and receiving and processing data of the air pressure sensor and the communication unit; and the communication unit communicates with the client in a wired or wireless communication manner.

Preferably, the air bag control unit further includes a sound sensor used for detecting whether the air pump works normally.

Preferably, the air bag control unit further includes a temperature sensor used for detecting heat caused by abnormal work of the air pump and the air valve.

An embodiment of the present disclosure further provides a self-checking method for an air bag, including the following steps:

S1, after air bags are inflated, closing all air pumps and air valves, and detecting air pressures of all the air bags;

S2, marking an air bag group with a stable air pressure as Group A, further analyzing air bag groups with unstable air pressures, marking an air bag group with an air pressure decreasing all the time as Group B, and marking an air bag group with an air pressure not decreasing all the time as Group C;

S3, further analyzing Group A in the step S2, inflating the air bags, marking an air bag and air valve group, in which the air pressure values of the air bags increase, as Group A1, and marking an air bag and air valve group, in which the air pressure values of the air bags do not increase, as Group A2, A1 indicating that the air bags, the air valves, and the air pressure sensors are all normal, and A2 indicating that the air valves are abnormal;

S31, deflating the air bags in Group A1 and turning off the air pumps at the same time; if the air pressures of the air bags decrease, indicating that the air pumps are normal and the deflating valves are normal; if the air pressures of the air bags do not decrease, indicating that the air pumps are faulted;

S32, deflating the air bags in Group A2 and turning off the air pumps at the same time; if the air pressures of the air bags decrease, indicating that the deflating valve systems are normal; if the air pressures of the air bags do not decrease, indicating that the deflating valves are faulted.

Further, the self-checking method for the air bag further includes:

S4A, further analyzing Group B in the step S2; turning on the air pumps for inflation; if the air pressures increase, marking an air bag group as B1, or marking the air bag group as B2, the step S4A and the step S3 not having a particular order.

Further, the step S4A is replaced as:

S4B, further analyzing Group B in the step S2; opening the deflating valves to deflate the air bags; if the air pressure decreases to the atmospheric pressure, marking the air bags as B1, or marking the air bags as B2.

Further, the step S4A or S4B is replaced as:

S4C, selecting one group of air bags in Group A, deflating the air bags until the air pressures are lower than the air pressures in Group B, and connecting the air bags to Group B; if the air pressure of Group B decreases, marking the air bags as B1, or marking the air bags as B2.

Specifically, in the above marking, B1 indicates that the air bags are abnormal, and B2 indicates that the air pressure sensors are abnormal.

The self-checking system and method for the air bag provided by the present disclosure are easy and convenient to operate and have wide coverage. All of the air pumps, the air valves (inflating and deflating), the air bags, and the air pressure sensors can be involved. Whether each component is faulted can be analyzed conveniently and quickly, and faults are displayed in the client for checking and repairing. The cost is low, and the efficiency is high.

### BRIEF DESCRIPTION OF THE DRAWINGS

To describe the embodiments of the present disclosure or the technical solutions in the existing art more clearly, drawings required to be used in the embodiments or the illustration of the existing art will be briefly introduced below. Obviously, the drawings in the illustration below are only some embodiments of the present disclosure. Those ordinarily skilled in the art also can acquire other drawings according to the provided drawings without doing creative work.

FIG. 1 is a schematic structural diagram of a self-checking system for an air bag provided by one embodiment of the present disclosure.

FIG. 2 is a flowchart for controlling, by an air bag control unit, an air valve in FIG. 1.

FIG. 3 is a schematic structural diagram of a self-checking system for an air bag provided by another embodiment of the present disclosure.

FIG. 4 is a schematic diagram of a self-checking process of a self-checking system for an air bag provided by an embodiment of the present disclosure.

FIG. 5 is a detailed flowchart of a self-checking method for an air bag provided by an embodiment of the present invention.

### DETAILED DESCRIPTION OF THE EMBODIMENTS

In order to make the technical problems, technical solutions and beneficial effects of the present disclosure clearer, the present disclosure is further described below in detail with reference to accompanying drawings and embodiments. It should be understood that the specific embodiments described here are merely to explain the present disclosure, and not intended to limit the present disclosure.

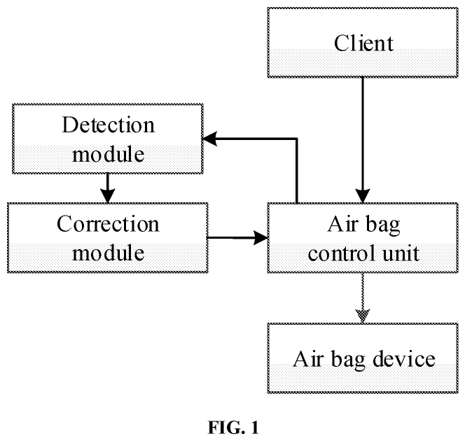

An embodiment of the present disclosure provides a self-checking system for an air bag, which is used for simultaneously detecting whether air bags, air valves, and air pressure sensors in an air bag adjustment system are faulted and finding out relevant problems, so as to achieve troubleshooting and complete self-repair. As shown in FIG. 1, the self-checking system for an air bag provided by the present disclosure includes a client, a detection module, and an air bag control unit, and further includes an air bag device. The air bag device may be an air bag mattress which includes an air bag and an air path. The air path is an air passageway, which is generally an air pipe. The detection module is used for detecting the air bag device and the air bag control unit according to preset steps.

Specifically, the air bag device is a mattress with a built-in air bag. The air bag mattress includes an air bag, an air pressure sensor, an air pump, an air valve, and other subassemblies.

In another embodiment, the air bag control unit and the air bag device are connected together. The air bag control unit is used for controlling the air bag to be inflated and deflated.

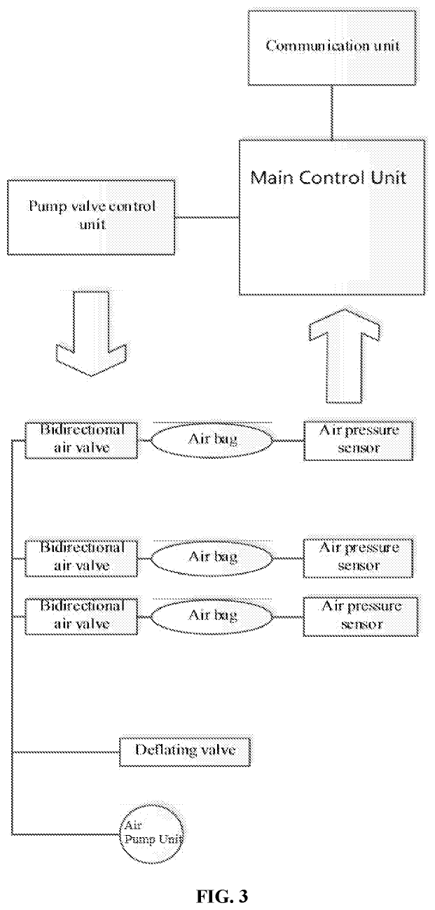

The air bag is used for storing air. The air pressure sensor is used for detecting an air pressure inside the air bag and transmitting the air pressure to a controller. The air pump is used for achieving inflation, or an air pump that has both an inflating function and a deflating function can also be provided. The air valve is used for controlling flowing of the air. The air valve includes a bidirectional air valve and a deflating valve. When the air bag is inflated, the air pump and the bidirectional air valve are turned on to inflate the air bag with air. During deflation, the bidirectional air valve and the deflating valve are opened, as shown in FIG. 3, so that the air in the air bag is discharged into the atmosphere. Each air bag is connected with one bidirectional air valve. The bidirectional air valve is opened in both air feeding and air discharging.

The air bag control unit controls feeding and discharging of the air by controlling the air valve to be opened and closed, so as to control the inflation and deflation of a certain specific air bag, the inflation and deflation amounts, and an inflating and deflating order.

The detection module is used for detecting, according to a signal fed back by the air bag control unit and set inflating and deflating states, whether each component (the air valve, the air bag, and the air pressure sensor) of the air bag mattress system is normal, mainly through changes of an air pressure value.

The client is a user control platform, which may be a touch screen display or a button display. The client may communicate with the air bag device (the air bag mattress) through wired or wireless (Bluetooth or WIFI) communication and is used for transmitting a detection instruction, displaying a detection result, and correcting results and related parameters. Further, the client can also upload the detection result to a cloud.

Preferably, the self-checking system for the air bag further includes a correction module. The correction module is used for receiving the detection result transmitted by the detection module and analyzing the result. After the detection result is transmitted to the correction module, the correction module is used for correcting the parameters of the air bag control unit, i.e., controlling the air pressure and opening and closing of the air valve, so as to achieve more accurate air bag adjustment and control and improve the safety. Specific corrected parameters include at least one of inflating and deflating order of the air bag, inflating and deflating time of the air bag, whether the air bag is inflated and deflated, and a detected value of an air pressure sensor.

In the present disclosure, the “air valve” includes the deflating valve and the bidirectional air valve. The deflating valve has one more deflating function than the bidirectional air valve. It is a three-way valve. The three-way valve is arranged on a main line. During inflation, the first end and the second end are opened. During deflation, the third end and the second end are opened. The bidirectional air valve is an air valve arranged in a straight pipeline, which is a conventional air valve. Air flow will pass through the bidirectional air valve in both inflation and deflation of the air bag. In the present disclosure, “Deflating valve is opened” means that the second end and the third end of the three-way valve are simultaneously opened, so that the air in the air bag is discharged into the atmosphere.

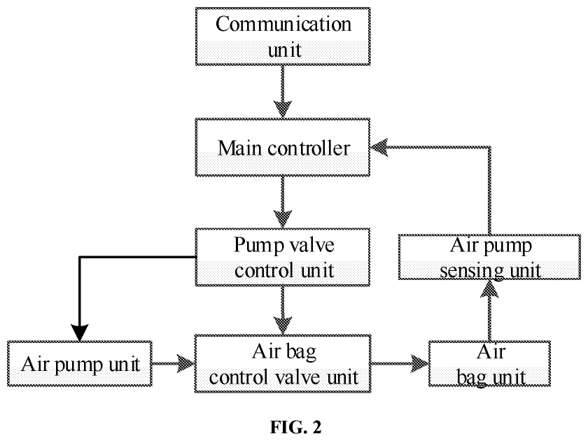

FIG. 2 is a flowchart for controlling, by the air bag control unit, the air valve in FIG. 1. The air bag control unit includes a communication unit, a main controller, a pump valve control unit, an air bag control valve unit, an air pump unit (including an air pump and an air valve, located in the mattress), an air bag unit (located in the mattress) and an air pump sensing unit (including an air pressure sensor). The communication unit sends an instruction to the main controller; the main controller then sends an instruction to the pump valve control unit; the pump valve control unit sends an instruction simultaneously to the air bag control valve and the air pump unit; the air valve control unit and the air pump unit are simultaneously turned on to inflate the air bag unit; and in the inflating process, the air pump sensing unit detects the air bag unit, acquires corresponding pressure information, and transmits the pressure sensing information to the main controller. The main controller determines, according to the information from the air pump sensing unit, whether states of the air bag control valve and the air bag unit are normal.

FIG. 3 is a schematic structural diagram of a self-checking system for an air bag in another embodiment. The air pump unit is connected with one main air valve (which also has the function of the deflating valve). The main air valve is a three-way valve which controls opening and closing of a main air pipe (an air flow pipeline) and also has a deflating function. The first end of the main air valve is connected with the air pump unit, and the second end is connected with each bidirectional air valve. These bidirectional air valves are respectively in one-to-one correspondence to the air bags and are connected to the air bags to control each air bag to be inflated and deflated. The third end of the main air valve is connected to the atmosphere. Each air bag is provided with an air pressure sensor for monitoring an air pressure of the air bag. Each air pressure sensor is connected with the main control unit to timely transmit the pressure information of the air bag to the main control unit. The main control unit is connected with the communication unit to transmit data to the client. The client analyzes and stores the data and uploads the data to the cloud. The above-mentioned communication unit is connected with the main controller in FIG. 2. One main air valve (three-way valve) in FIG. 3 controls three bidirectional air valves (branch air valves) m and the three bidirectional air valves control three air bags. The air pump is turned on. The first end and the second end of the main air valve are opened. The bidirectional air valves are all opened to inflate all the air bags. At this time, the air pressure sensors monitor changes of the air pressures of the air bags. If the air pressure of a certain air bag does not increase, it is determined that the air bag or the corresponding bidirectional air valve is faulted and needs to be repaired or replaced. The main control unit reports an error to the client. A screen of the client displays that the corresponding air bag or bidirectional air valve is faulted. After the deflation ends, the air valve is closed, and the air pressure in the air bag is kept constant. At this time, the air pressure sensor continues to monitor the air pressure. If the air pressure slowly decreases at this time, it is indicated that the air bag or the air valve has air leakage and needs to be repaired or replaced.

Specifically, the air pressure sensor is arranged on the air bag or inside the air bag. The structure of the sensor is familiar to those skilled in the art.

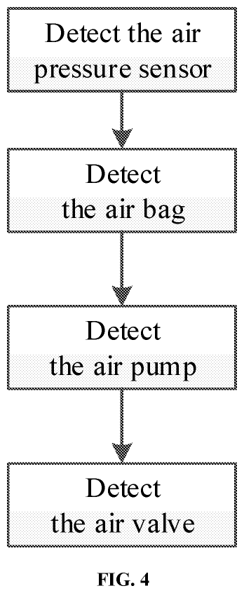

FIG. 4 illustrates a self-checking process of a self-checking system for an air bag provided by an embodiment of the present disclosure. The air pressure sensor, the air bag, the air pump, and the air valve are detected in sequence. In other embodiments, the detection order may not be limited. For example, the air pressure sensor, the air bag, the air pump, and the air valve are simultaneously detected.

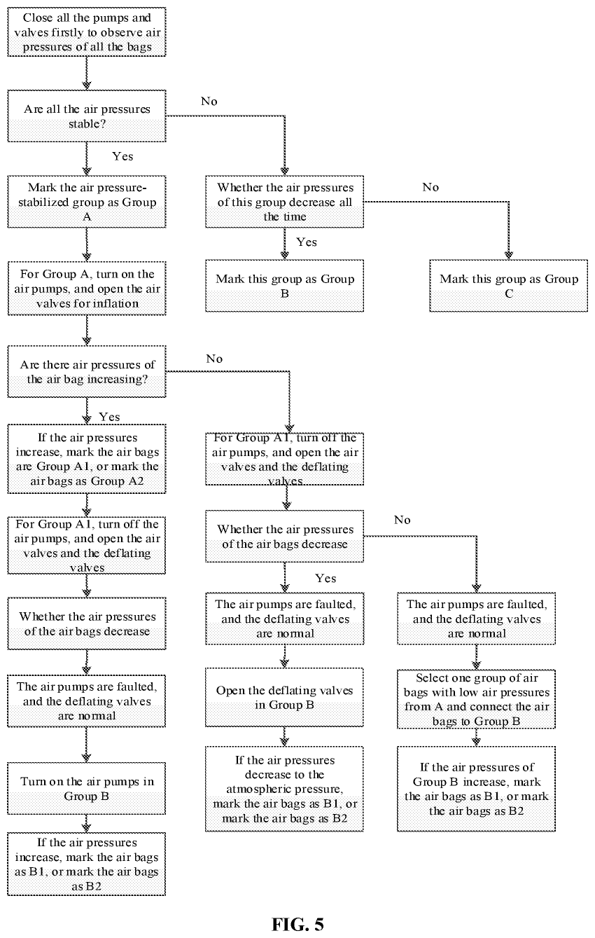

FIG. 5 illustrates a detailed flowchart of a self-checking method for an air bag provided by an embodiment of the present invention. As shown in the figures, after the air bags are inflated, all the pumps and valves (the air pumps and the air valves) are turned off first to stop inflation and deflation and observe changes of the air pressures of all the air bags. The air pressure sensors detect whether the air pressures are stable. The detection time is, for example, 3 to 30 min. If the air pressures are stable, an air pressure-stabilized group (or individual air bags) is marked as Group A. An air pressure-not-stabilized group may possibly have air leakage. The air pressure-not-stabilized group is further analyzed. Classification is carried out according to whether the air pressure decreases all the time. Air bags with the air pressures decreasing all the time are marked as Group B, and air bags with the air pressures not decreasing all the time are marked as Group C (Group C indicates that the air pressure sensors are abnormal). At the same time, for Group A (the air pressure-stabilized group), the air pumps and the bidirectional air valves are turned on for inflation, and the pressures are detected. If the air pressures of the air bags increase, the air bags are marked as Group A1. If the air pressures of the air bags do not increase, the air bags are marked as Group A2. For Group A1, the air pumps are turned off, and the deflating valves and the bidirectional air valves are opened; whether the air pressures of the air bags decrease are detected. If the air pressures decrease, it is indicated that the air bags are normal, the air valves are normal, and the air pressure sensors are normal. They can continue to work and do not need to be repaired. If the air pressures do not decrease, it is indicated that the air valves cannot be deflated, but they need to be repaired or replaced. After the air bags, the air valves, and the air pressure sensors of Group A1 are detected to be normal, for Group B, the air pumps are turned on to inflate the air bags. If the air pressures of the air bags increase, the air bags are marked as B1. If the air pressures do not increase, the air bags are marked as B2. For Group A2, the air pumps are turned off, and the deflating valves and the bidirectional air valves are opened to detect whether the air pressures of the air bags decrease. If the air pressures of the air bags decrease, it is indicated that the air pumps of Group A2 are faulted, and the air valves are normal. For Group B, the deflating valves and the bidirectional air valves are opened for deflation. If the air pressures of the air bags do not decrease, it is indicated that the air pumps are faulted, and the air valves are also faulted. A group of air valves and air bags with low air pressures are selected for combination from Group A and are connected to Group B. For the case where the air valves of Group B are directly opened for deflation, if the air pressures decrease to the atmospheric pressure, the air bags are marked as B1, or the air bags are marked as B2. For the case where a group of air valves and air bags with low air pressures are selected for combination from Group A and are connected to Group B, if the air pressures of Group B increase, the air bags are marked as B1, or the air bags are marked as B2. Final conclusions are as follows: In FIG. 5, A1 indicates that the air bags, the air valves, and the air pressure sensors are all normal; A2 indicates that the air valves are abnormal; B1 indicates that the air bags are abnormal; and B2 indicates that the air pressure sensors are abnormal.

The self-checking system for the air bag provided by the present disclosure is simple in structure. The ventilation system is turned on and turned off according to a certain order, so that whether the air bags, the air valves, and the air pressure sensors in the air bag mattress are all faulted can be analyzed in combination with the data detected by the air pressure sensors. The operation is convenient.

An embodiment of the present disclosure further provides an air bag repair system, including the above-mentioned self-checking system for an air bag.

An embodiment of the present disclosure further provides a self-checking method for an air bag, referring to FIG. 5, including the following steps:

S1, after air bags are inflated, closing all air pumps and air valves, and detecting air pressures of all the air bags;

S2, marking an air bag group with a stable air pressure as Group A, further analyzing air bag groups with unstable air pressures, marking an air bag group with an air pressure decreasing all the time as Group B, and marking an air bag group with an air pressure not decreasing all the time as Group C;

S3, further analyzing Group A in the step S2, inflating the air bags, marking an air bag and air valve group, in which the air pressure values of the air bags increase, as Group A1, and marking an air bag and air valve group, in which the air pressure values of the air bags do not increase, as Group A2, A1 indicating that the air bags, the air valves, and the air pressure sensors are all normal, and A2 indicating that the air valves are abnormal;

S31, deflating the air bags in Group A1 and turning off the air pumps at the same time; if the air pressures of the air bags decrease, indicating that the air pumps are normal and the deflating valves are normal; if the air pressures of the air bags do not decrease, indicating that the air pumps are faulted;

S32, deflating the air bags in Group A2 and turning off the air pumps at the same time; if the air pressures of the air bags decrease, indicating that the deflating valve systems are normal; if the air pressures of the air bags do not decrease, indicating that the deflating valves are faulted.

In the above steps, S31 and S32 are executed after S3, and there is no order for S31 and S32.

Further, the self-checking method for the air bag mattress further includes:

S4A, further analyzing Group B in the step S2; turning on the air pumps for inflation; if the air pressures increase, marking an air bag group as B1, or marking the air bag group as B2, the step S4A and the step S3 do not have a particular order.

Further, the step S4A is replaced as:

S4B, further analyzing Group B in the step S2; opening the deflating valves to deflate the air bags; if the air pressure decreases to the atmospheric pressure, marking the air bags as B1, or marking the air bags as B2.

In another embodiment, the above step S4A or S4B may be replaced as:

S4C, selecting one group of air bags in Group A, deflating the air bags until the air pressures are lower than the air pressures in Group B, and connecting the air bags to Group B; if the air pressure of Group B decreases, marking the air bags as B1, or marking the air bags as B2.

Specifically, in the above marking, B1 indicates that the air bags are abnormal, and B2 indicates that the air pressure sensors are abnormal.

In specific application, the detection module displays the detection result in the client. A1 indicates that the whole air bag mattress is completely normal and can be continued to be used. A2 prompts that the air valves are faulted and can be repaired or directly replaced with new air valves. B1 indicates that the air bags are faulted and need to be repaired. B2 indicates that the air pressure sensors are faulted and need to be repaired.

The method provided by the present disclosure can accurately detect the fault of any component from among the air pump, the air bag, the air valve, and the air pressure sensor in the air bag mattress, has high efficiency, is convenient to popularize, and is also applicable to other technical fields where an air bag system is used.

An embodiment of the present disclosure further provides an air bag mattress repair method, including the above-mentioned self-checking method for an air bag. After the above-mentioned self-checking method for an air bag is used to detect the corresponding fault, targeted repair or replacement is carried out.

The above descriptions are only the preferred embodiments of the present disclosure, and are not intended to limit the present disclosure. Any modifications, equivalent replacements and improvements that are made within the spirit and principle of the present disclosure shall fall within the protection scope of the present disclosure.

What is claimed is:

1. A self-checking method for an air bag, comprising:
S1, after air bags are inflated, closing all air pumps and air valves, and detecting air pressures of all the air bags;
S2, marking an air bag group with a stable air pressure as Group A, further analyzing air bag groups with unstable air pressures, marking an air bag group with an air pressure decreasing all the time as Group B, and marking an air bag group with an air pressure not decreasing all the time as Group C;
S3, further analyzing Group A in the step S2, inflating the air bags, marking an air bag and air valve group with increasing air pressure values in the air bags as Group A1, and marking an air bag and air valve group without increasing air pressure values in the air bags as Group A2, wherein A1 indicates that the air bags, the air valves, and the air pressure sensors are all normal, and A2 indicates that the air valves are abnormal;
S31, deflating the air bags in Group A1 and turning off the air pumps at the same time; if the air pressures of the air bags decrease, which indicates that the air pumps are normal and the deflating valves are normal; if the air pressures of the air bags do not decrease, which indicates that the air pumps are faulted;
S32, deflating the air bags in Group A2 and turning off the air pumps at the same time; if the air pressures of the air bags decrease, which indicates that the deflating valve systems are normal; if the air pressures of the air bags do not decrease, which indicates that the deflating valves are faulted.

2. The self-checking method of claim 1, further comprising:
S4A, further analyzing Group B in the step S2 by turning on the air pumps for inflation; if the air pressures increase, marking an air bag group as B1, or marking the air bag group as B2, wherein the step S4A and the step S3 do not have a particular order.

3. The self-checking method of claim 2, wherein the step S4A is replaced as:
S4B, further analyzing Group B in the step S2 by opening the deflating valves to deflate the air bags; if the air pressure decreases to the atmospheric pressure, marking the air bags as B1, or marking the air bags as B2.

4. The self-checking method of claim 3, wherein the step S4A or S4B is replaced as:
S4C, selecting one group of air bags in Group A, deflating the air bags until the air pressures are lower than the air pressures in Group B, and connecting the air bags to Group B; if the air pressure of Group B decreases, marking the air bags as B1, or marking the air bags as B2.

5. The self-checking method of claim 1, wherein B1 indicates that the air bags are abnormal, and B2 indicates that the air pressure sensors are abnormal.
